(19) United States
(12) Patent Application Publication
(10) Pub. No.: US 2009/0020703 A1
(43) Pub. Date: Jan. 22, 2009

(54) OPTICAL FILTER FOR IMPROVED WHITE LIGHT IMMUNITY IN AN INTRUSION DETECTOR

(75) Inventors: Mark C. Buckley, Pollock Pines, CA (US); Kevin M. Pelletier, Rocklin, CA (US); Jeffrey L. Blitstein, Folsom, CA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc, Morristown, NJ (US)

(21) Appl. No.: 11/778,742

(22) Filed: Jul. 17, 2007

(51) Int. Cl. G01J 5/00; G01J 5/02; G01J 1/00

(52) U.S. Cl. 250/338.3; 250/340; 359/580

(57) ABSTRACT

An optical filter device for filtering radiation energy includes a substrate having a plurality of coating layers which are both transmissive to a specified wavelength band of radiation. The plurality of coating layers on a surface of the substrate each have a specified coating thickness. The plurality of coating layers cause destructive interference and/or reflection of the radiation outside the specified wavelength band of the radiation while radiation within the specified wavelength band is passed through the substrate and the plurality of coating layers. The substrate or window/filter may be positioned in a housing between a receiving element such as a pyroelectric element and the radiation energy wherein the specified wavelength band of radiation passes through the substrate and plurality of coating layers to the pyroelectric element. A signaling device communicates a signal indicating when the radiation energy within the specified wavelength band reaches the at least one pyroelectric element.

### FIELD OF THE INVENTION

The present invention relates to a radiation sensor device, and more specifically, a radiation sensor device including a multiple layer coating filter for selectively allowing transmission of radiation of specific wavelengths to a pyroelectric element within the device.

### BACKGROUND OF THE INVENTION

Currently, pyroelectric sensors are used in intrusion detection devices to identify intruders. Pyroelectric elements are sensitive to infrared light at wavelengths emitted by the human body, i.e., a wavelength band of about 7 to 25 μm. However, pyroelectric elements are also sensitive to broadband radiation which includes ultraviolet, infrared, and visible light. Much of this radiation is outside the wavelength band emitted by humans, and predominantly emitted by objects having external temperatures of around 300 degrees Kelvin. To minimize false alarms, a typical pyroelectric sensing device 10, as shown in FIG. 1, used in intrusion detection contains a window (or filter) 14 which filters, i.e., minimizes the transmission of wavelengths, for example, below 5 μm. More specifically, the window 14 is typically formed using a substrate 104 (shown in FIG. 2) which may be comprised of silicon. Silicon absorbs radiation energy below 1.1 μm and passes radiation energy above 1.1 μm. Filtering of the wavelengths from 1.1 to 5.0 μm is achieved by placing layers 108 of other materials on the silicon substrate 104. The material in these layers must pass the wavelengths of interest (7.0 to 25.0 μm), while filtering the wavelengths from 1.1 to 5.0 μm. Each material by itself can either absorb or reflect some of the wavelengths not passed.

Referring to FIGS. 1 and 2, the known pyroelectric sensing device 10 is shown including a window 14 attached to a housing lid 18. A printed circuit board assembly 22 includes one or more pyroelectric elements, and in the embodiment shown in FIGS. 1 and 2, two pyroelectric elements 26 are shown. The circuit board 22 is attached to a housing base 30 which includes electrical leads 34 to transmit the electrical signal to a microprocessor. If the electrical signal satisfies preset conditions, the microprocessor will transmit an alarm signal to an alarm system or monitoring device. As shown in FIG. 2, the substrate 104 includes a plurality of coating layers 108 to form the window/filter 14. The coating layers 108 transmit, reflect, absorb, or cause destructive interference of radiation being focused at the window 14. A secondary filter (not shown) may be placed in front of the window 14 such that window 14 is a primary filter working in conjunction with the secondary filter to selectively reflect and pass radiation energy.

The pyroelectric sensing device 10 is inherently susceptible to detecting stimuli not associated with intrusion which results in false alarms and/or false detections. Specifically pyroelectric sensing devices are susceptible to the radiation energy produced by automobile head lights and other light sources emanating from outside the region being protected, but penetrating into the field-of-view of the pyroelectric device, and ultimately onto the pyroelectric device package. The energy produced by automobile headlamps can be sufficient to cause an alarm in a pyroelectric sensing device. False alarms in intrusion systems are a significant distraction and loss of man hours for the police force, and also can be costly in fines to the owners of the security systems.

Current approaches to solving this problem include augmenting the blocking ability of the pyroelectric sensors window/filter to block unwanted radiation energy. Typically, this includes adding materials, sometimes pigmenting agents (e.g. Zinc Sulfide) to the lens to make the lens more opaque to white light or visible light (energy radiation at wavelengths which the human eye can see) while passing IR (infrared) energy/radiation, or may include addition of a secondary filter. Typically, the amount of a white light absorbing substance added to a passive infrared (PIR) intrusion detector lens to ensure ignoring car headlights is significant, and has an adverse effect on lens transmission in the infrared realm, which may impair the ability of the pyroelectric sensor to detect an intruder, Lens transmission may be reduced by at least 30% in the IR wavelength band between 5 and 25 μm when adequate amounts of pigmentation are added.

Another approach to solving the problem of false alarms is adding a secondary filter to an intrusion detector to ensure that the pyroelectric sensing device ignores car headlights, Secondary filters add significantly to the cost of the intrusion detector and may reduce the IR transmission by approximately 20%. Thus, when intrusion detectors incorporate secondary filters to ensure the pyroelectric sensing device ignores car headlights, the detector may not detect an intruder because the secondary filter reduces the amount of energy that will reach the pyroelectric elements. Further, secondary filters also alter the optical path between each lens element and the pyroelectric elements, which may distort the intended protection pattern.

Additionally, energy between 0.4 and 1.8 μm reaching the pyroelectric sensor, for example from an automobile headlamp, is significant and may result in a pyroelectric sensor signal sufficient to cause a motion sensor to send an alarm. Specifically, the typical pyroelectric sensor contains a filter that does not transmit energy in this wavelength band because the energy is absorbed by silicon and coating layers. However, as the filter absorbs this energy, the energy is converted into heat. This heat is re-radiated at a longer wavelength, passes through the filter and is detected by the pyroelectric element(s). The filters used in typical pyroelectric sensors today may contain layers which cause destructive interference in the 1.8 to 5.0 μm wavelength band.

In current pyroelectric sensor devices, the filter prevents wavelengths below 5 μm from reaching the pyroelectric elements. This is achieved via reflection, absorption and destructive interference. The materials typically used will absorb radiation energy below 1.8 μm. To achieve the rejection of radiation between 1.8 and 5 μm, layers of material having different indices of refraction may be applied in specified layer thicknesses to cause an out of phase reflection which, in turn, causes destructive interference of the desired wavelengths. Many layers of materials having different indices of refraction are needed to cover a wide wavelength band of energy. Typical Silicon filters in pyroelectric sensors contain multiple alternating layers of materials, for example, Germanium and Zinc Sulfide. For example, Germanium absorbs energy below 1.8 μm, and Zinc Sulfide absorbs energy below 0.9 μm.

Thus, a drawback to current pyroelectric sensing devices is the susceptibility of the window/filter to absorb energy in close proximity to the sensing elements (ie. the housing and most significantly the optical filter). Although the pyroelectric sensors' window/filter blocks energy below 5 μm, a large portion of this blocking comes in the form of energy absorption and a smaller portion from destructive interference and reflection. The absorbed energy is converted into heat, which is re-radiated at wavelengths that pass through the filter to the sensitive pyroelectric elements, thereby generating an electrical response leading to a false alarm from detection of the energy source.

It would therefore be desirable to provide a pyroelectric sensing device and method that filters out unwanted energy without producing heat and the undesirable re-radiation of energy in order to substantially eliminate false alarms/detections without the shortcomings of current devices and methods. It would further be desirable to provide a optical filter which prevents visible and near infrared radiation (NIR) energy from reaching the pyroelectric element. Also, it would be desirable to simplify manufacturing, reduce costs, and improve reliability of current pyroelectric sensing device devices. Such a filter would be useful in other IR energy detecting devices such as thermopiles and bolometers.

### SUMMARY OF THE INVENTION

In an aspect of the present invention an optical filter device comprises a substrate having a plurality of coating layers on a surface of the substrate. The plurality of coating layers and the substrate are transmissive to a specified wavelength band of radiation. The plurality of coating layers on the substrate each have a specified coating thickness. The plurality of coating layers cause destructive interference of radiation outside the specified wavelength band of radiation while the radiation within the specified wavelength band passes through the substrate and the plurality of coating layers.

In a related aspect, the plurality of coating layers cause destructive interference and reflection of the radiation outside the specified wavelength band of radiation, and the radiation within the specified wavelength band passes through the substrate and the plurality of coating layers.

In a related aspect, the plurality of coating layers on the substrate cause destructive interference of a first group of wavelength bands of radiation outside the specified wavelength band of radiation. Further, the plurality of coating layers cause reflection of a second group of wavelength bands of radiation outside the specified wavelength band of radiation, and both the first and second groups of wavelengths are different from one another and outside the specified wavelength band of radiation.

In a related aspect, the substrate is positioned between a receiving element and a source of radiation.

In a related aspect, the receiving element includes a pyroelectric element.

In a related aspect, the substrate is positioned in a housing; and at least one receiving element is positioned within the housing. The substrate is positioned between the at least one receiving element and the source of radiation, and the radiation within the specified wavelength band passes through the substrate and the plurality of coating layers to the at least one receiving element for initiating an electrical signal.

In a related aspect, the device further including multiple receiving elements.

In a related aspect, the housing is mounted in a case which further includes an electronic device for receiving an electrical signal generated from the at least one receiving element and initiating an alarm signal when a specified level of radiation within the specified wavelength band reaches the at least one receiving element.

In another aspect of the invention, an optical filter device comprises a substrate having a plurality of coating layers on a surface of the substrate. The plurality of coating layers and the substrate are transmissive to a specified wavelength band of radiation. The plurality of coating layers on the substrate each having a specified coating thickness, and the plurality of coating layers causing reflection of radiation outside the specified wavelength band of radiation while the radiation within the specified wavelength band passes through the substrate and the plurality of coating layers.

In a related aspect, the substrate is positioned between a receiving element and a source of radiation.

In a related aspect, the receiving element includes a pyroelectric element.

In a related aspect, the device further includes multiple receiving elements.

In a related aspect, the substrate is positioned in a housing, and at least one receiving element is positioned within the housing. The substrate is positioned between the at least one receiving element and a source of radiation, and the radiation within the specified wavelength band passes through the substrate and the plurality of coating layers to the at least one receiving element for initiating an electrical signal.

In a related aspect, the housing is mounted in a case which further includes an electronic device for receiving an electrical signal generated from the at least one receiving element and initiating an alarm signal when a specified level of radiation within the specified wavelength band reaches the at least one receiving element.

In another aspect of the invention, a pyroelectric sensing device comprises a housing. A substrate is attached to the housing and the substrate has a plurality of coating layers on a surface of the substrate. The plurality of coating layers and the substrate are transmissive to a specified wavelength band of radiation. The plurality of coating layers on the substrate each have a specified coating thickness, and the plurality of coating layers causing destructive interference of radiation outside the specified wavelength band of radiation. At least one pyroelectric element is positioned within the housing, and the substrate is positioned between the at least one pyroelectric element and radiation. The radiation within the specified wavelength band passes through the substrate and the plurality of coating layers to the at least one pyroelectric element for initiating an electrical signal.

In a related aspect, the specified wavelength band is between about 7 and 25 μm (micrometers).

In a related aspect, the plurality of coating layers cause destructive interference below the wavelength of about 5 μm.

In a related aspect, the plurality of coating layers cause destructive interference between about 0.4 to 5 μm.

In a related aspect, the plurality of coating layers cause destructive interference and reflection of the radiation outside the specified wavelength band of radiation while the radiation within the specified wavelength band passes through the substrate and the plurality of coating layers.

In a related aspect, the plurality of coating layers on the substrate cause destructive interference of a first group of wavelength bands of radiation outside the specified wavelength band of radiation, and the plurality of coating layers on the substrate causes reflection of a second group of wavelength bands of radiation outside the specified wavelength band of radiation. Both the first and second groups of wavelength are different from one another and outside the specified wavelength band of radiation.

In a related aspect, the housing is mounted in a case which further includes an electronic device for receiving the electrical signal generated from the at least one pyroelectric element. The electronic deice initiates an alarm signal when the radiation within the specified wavelength band reaches the at least one pyroelectric element and the electronic device determines when the electrical signal exceeded a threshold value.

In a related aspect, the housing is mounted to a printed circuit board (PCB) in the case and further mounted to the PCB) is an amplifier for amplifying the electrical signal, and an alarm relay for relaying the alarm signal from the electronic device to a signaling device.

In another aspect of the invention, a pyroelectric sensing device comprises a housing. A substrate is attached to the housing and the substrate has a plurality of coating layers on a surface of the substrate, the plurality of coating layers and the substrate being transmissive to a specified wavelength band of radiation. The plurality of coating layers on the substrate each have a specified coating thickness, and the plurality of coating layers causing reflection of radiation outside the specified wavelength band of radiation. At least one pyroelectric element is positioned within the housing, and the substrate is positioned between the at least one pyroelectric element and radiation. The radiation within the specified wavelength band passes through the substrate and the plurality of coating layers to the at least one pyroelectric element for initiating an electrical signal.

In a related aspect, the specified wavelength band is between about 7 and 25 μm (micrometers).

In a related aspect, the plurality of coating layers cause reflection below the wavelength of about 5 μm.

In a related aspect, the plurality of coating layers cause reflection between about 0.4 to 5 μm.

In a related aspect, the housing is mounted in a case which further includes an electronic device for receiving the electrical signal generated from the at least one pyroelectric element. The electronic device initiates an alarm signal when the radiation within the specified wavelength band reaches the at least one pyroelectric element and the electronic device determines that the electrical signal exceeded a threshold value.

In a related aspect, the housing is mounted to a printed circuit board (PCB) in the case and further mounted to the PCB is an amplifier for amplifying the electrical signal. An alarm relay relays the alarm signal from the electronic device to a signaling device.

In another aspect of the invention, a method for detecting intrusion comprises providing an optical filter device being transmissive to a specified wavelength band of radiation; applying a plurality of coating layers on the substrate each having a specified coating thickness; passing a specified wavelength band of radiation through the coating layers and the substrate; and interfering destructively with radiation outside the specified wavelength band of radiation using the plurality of coating layers.

In a related aspect, the plurality of coating layers interfering destructively and reflecting the radiation outside the specified wavelength band of the radiation while passing the radiation within the specified wavelength band through the plurality of coating layers and the substrate.

In a related aspect, the method further comprises the step of reflecting a first group of at least one specified wavelength band of the radiation, and destructively interfering a second group of at least one specified wavelength band of the radiation, and both the first and second groups of specified wavelength bands are different from one another and outside the specified wavelength band.

In a related aspect, the method further includes positioning the substrate between a receiving element and a source of radiation.

In a related aspect, the method further includes positioning at least one pyroelectric element within a housing; positioning the substrate between the at least one pyroelectric element and radiation; and initiating an electrical signal by passing energy within the specified wavelength band of radiation through the plurality of coating layers and the substrate to the at least one pyroelectric element.

In another aspect of the invention, a method for detecting intrusion comprises providing an optical filter device being transmissive to a specified wavelength band of radiation; applying a plurality of coating layers on the substrate each having a specified coating thickness; passing a specified wavelength band of radiation through the coating layers and the substrate; and reflecting radiation outside the specified wavelength band of radiation using the plurality of coating layers.

In a related aspect, the method further includes positioning the substrate between a receiving element and a source of radiation.

In a related aspect, the method further includes positioning at least one pyroelectric element within a housing; positioning the substrate between the at least one pyroelectric element and radiation; and initiating an electrical signal by passing energy within the specified wavelength band of radiation through the plurality of coating layers and the substrate to the at least one pyroelectric element.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is an exploded view of a prior art pyroelectric sensor depicting a window/filter;

FIG. 2 is an exploded view of the prior art window/filter shown in FIG. 1 depicting multiple coating layers on a substrate;

FIG. 3 is an exploded view of an embodiment of a pyroelectric sensor according to the present invention depicting a window/filter, a housing, printed circuit board (PCB) and a housing base having electrical leads which connect to a main circuit board depicting a microprocessor, amplifier, and alarm relay shown in FIG. 7;

FIG. 4 is an exploded view of the window/filter shown in FIG. 3 depicting multiple coating layers on a substrate according to the present invention;

FIG. 5 is a cross-sectional side elevational view of the window shown in FIG. 3 depicting radiation energy and the pyroelectric elements mounted on the pyroelectric PCB;

FIG. 6 is a perspective view of an embodiment of a Passive Infrared (PIR) motion detector according to the present invention depicting a front cover having a lens, and a mating rear cover; and

FIG. 7 is a perspective view of the PIR motion detector shown in FIG. 6 with the front cover and lens removed depicting the pyroelectric sensor shown in FIG. 3, a main printed circuit board (PCB), a microprocessor, an amplifier, and an alarm relay, mounted in the rear cover.

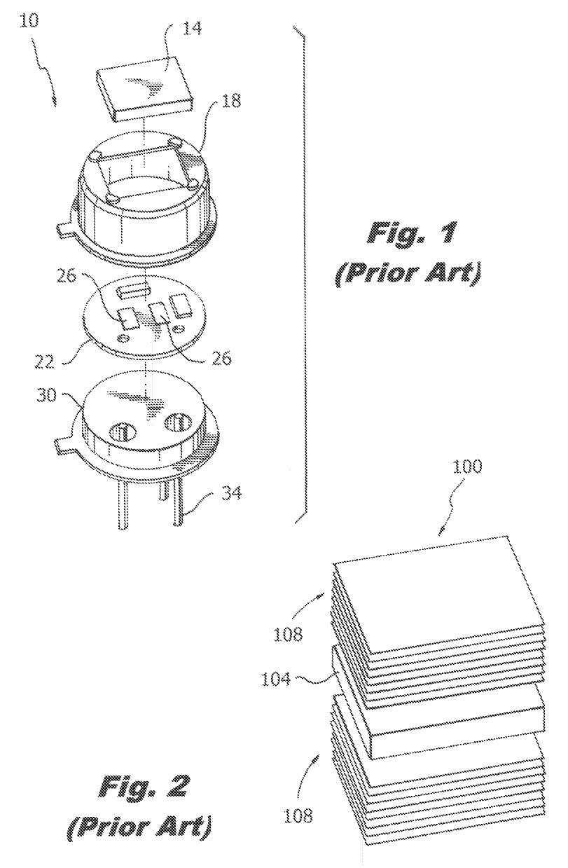

### DETAILED DESCRIPTION OF THE INVENTION

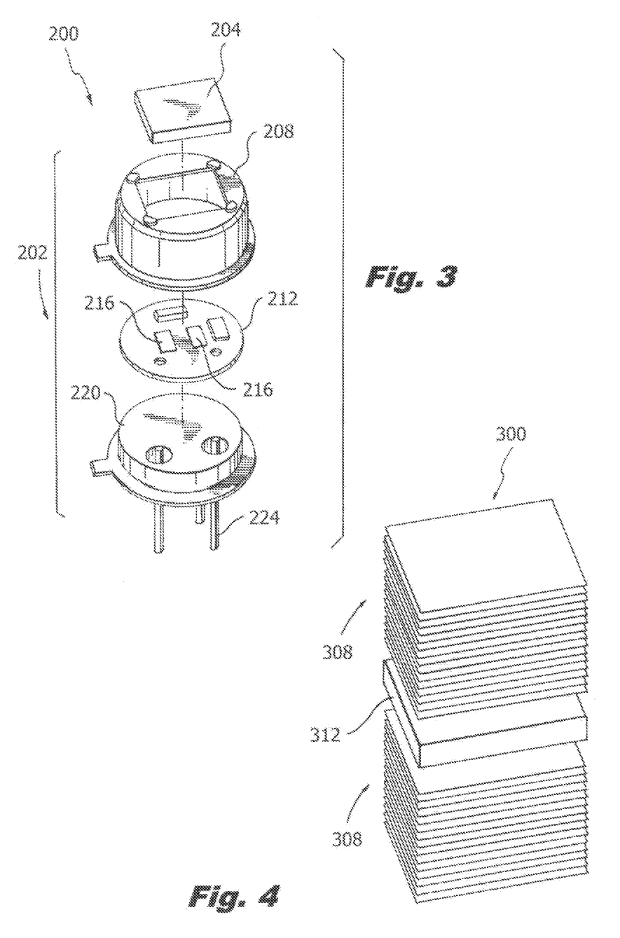

Generally, the present invention includes a device using an optical filter for prohibiting energy absorption by blocking undesirable wavelength bands of radiation. Specifically, the device selectively allows or prevents wavelength bands of radiation from reaching a receiving element, which may include, for example, a pyroelectric element. Further, the present invention includes a pyroelectric sensing device and method for detecting intrusion The pyroelectric sensing device according to the present invention prohibits energy absorption in an optical filter by blocking undesirable wavelength bands of radiation. The present invention eliminates the radiation energy in the undesirable wavelengths that would otherwise be absorbed in the filter. The undesirable radiation is eliminated by destructive interference and/or by reflecting the radiation energy. According to the present invention, a desired wavelength band of infrared energy is allowed to transmit through the primary optical filter or window 204 (shown in FIGS. 3 and 5). However, the present invention eliminates absorption of out of band energy by using destructive interference and reflection of selected wavelengths, thereby eliminating re-radiated heat effects.

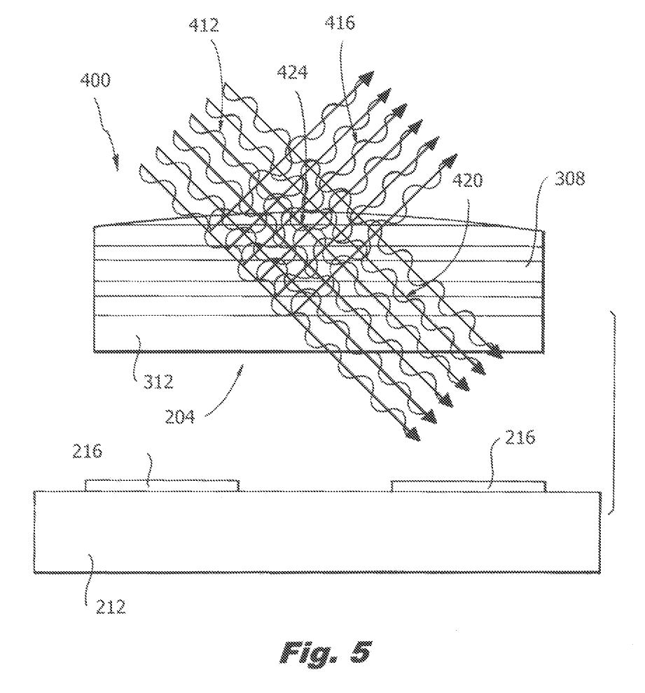

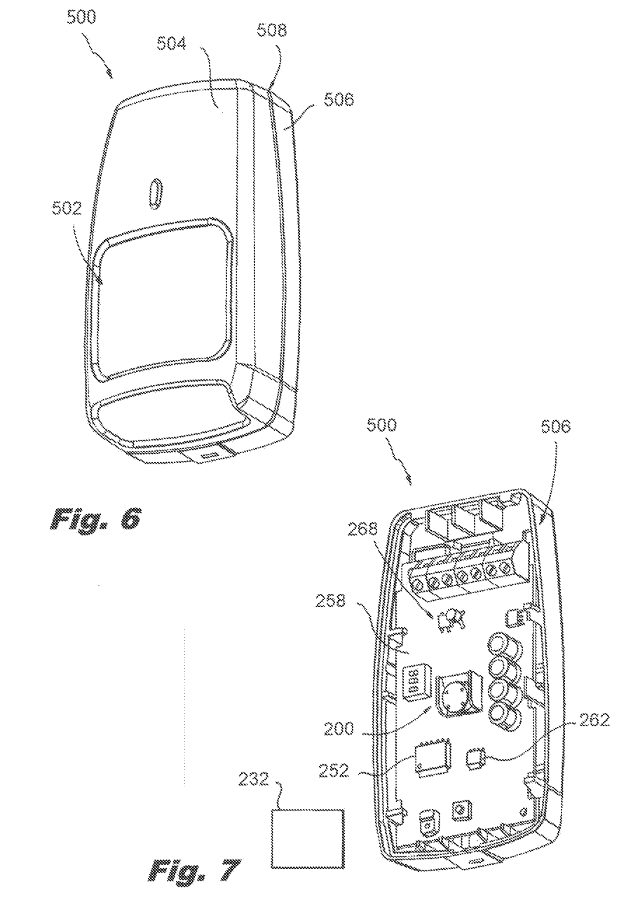

Referring to FIGS. 3 and 4, an illustrative embodiment of a pyroelectric sensor device 200 according to the present invention includes a housing 202. The housing 202 includes a window or filter 204 attached to a housing lid 208. The housing lid 208 mates with a housing base 220 to house a printed circuit board (PCB) 212. The printed circuit board assembly 212 includes two pyroelectric elements 216, and may in alternative embodiments include one or multiple pyroelectric elements. The circuit board 212 is attached to the housing base 220 which includes electrical leads 224 to transmit an electrical signal to an alarm system or monitoring device 232 via a main PCB 258 mounted in a case embodied as intrusion detector 500 (shown in FIGS. 6 and 7). A substrate 312 includes a plurality of coating layers 308. The plurality of coating layers 308 formed on the substrate 312 forms the window 204. The coating layers 308 reflect and cause destructive interference of selected wavelengths of radiation being focused at the window 204, as discussed below.

Referring to FIGS. 6 and 7, the pyroelectric sensor device 200 is mounted on the main printed circuit board (PCB) 258 of the intrusion detector 500. The intrusion detector includes a front cover 504 having a lens 502, and a mating rear cover 506 forming a case 508. The intrusion detector 500 further includes a microprocessor 252 mounted on the main PCB 258 affixed in the rear cover 506 for determining if an alarm threshold is achieved. The electrical signal is amplified by amplifier 262 mounted on the main PCB 258, before being processed by the microprocessor 252. The microprocessor 252 applies and removes power from a relay 268 also mounted on the main PCB 258. The relay 268 opens and closes an alarm circuit communicating with an alarm system control panel 232.

More specifically, referring to FIGS. 3-7, according to an illustrative embodiment of the present invention, a pyroelectric sensing device 200 is provided which prohibits energy absorption in the devices window/filter 204 while blocking out undesirable wavelengths (5 μm and below), and passing wavelengths of interest (7 to 25 μm) 420 to the pyroelectric elements 216 on the circuit board 212, as shown in FIG. 5. This is achieved by eliminating energy absorption via destructive interference 424 and/or reflection 416, shown in FIG. 5. The present invention achieves destructive interference of a select band of infrared wavelengths by placing multiple coating layers 308 on a substrate 312, where the multiple coating layers pass the wavelengths of interest 420 as shown in FIG. 5. For destructive interference, a difference in the index of refraction and thickness of each layer results in the energy being reflected back on itself out of phase 424, which results in a cancellation of the incident energy, as depicted in FIG. 5. Further, the coating layers reflect specified wavelengths and pass the wavelengths of interest (7 to 25 μm). The coating layers 308 are applied on both sides of the substrate 312 so the resulting filter 204 does not have to be specifically orientated during assembly. Alternatively, the coating layers 308 can be applied to one side of the substrate and then be specifically orientated during assembly.

In operation, again referring to FIGS. 3- 7, when the pyroelectric sensor's window/filter 204 passes wavelengths of interest, the absorption of radiation by the pyroelectric element 26 causes the elements 26 to heat up. The pyroelectric elements 26 generate an electrical signal proportional to the rate of temperature change as a result of the pyroelectric effect. The electrical signal comes out of the pyroelectric elements via the circuit board 212 in pyroelectric sensor device housing and is received via the electrical leads 224 by the main PCB 258. Thereafter, the electrical signal is amplified by amplifier 262 mounted on the main PCB 258, and then processed by a microprocessor 252 mounted on the main printed circuit board 258. The microprocessor 252 determines the alarm state of the intrusion detector 500 by determining if an alarm threshold is achieved. The alarm threshold is attained when the amplified pyroelectric sensor device electrical signal is greater than a predetermined value. At that point, the intrusion detector 500 sends an alarm signal to an alarm system control panel 232. This is achieved by the microprocessor 252 removing power from the relay 268 on the main PCB 258 which opens the relay or alarm circuit. The open circuit is interpreted by the alarm system control panel 232 as an alarm. The control panel communicates with the relay 268 of the detector 500, for example, by a wired connection. An alarm can be generated from the control panel 232, as well as, transmitted to a remote receiving device, a monitoring station, and to alert emergency personnel.

In the embodiment of the invention shown in FIGS. 3-5, the coating layers 308 prevent the radiation energy between 0.4 and 5.0 μm from reaching the pyroelectric elements 216. The coating layers 308 reflect and/or eliminate by destructive interference the radiation energy between 0.4 and 5.0 μm. Thus, lens pigmenting and opaquing additives and secondary filters (not shown) are not necessary. An advantage of the device and method of the present invention is the reduction of cost of the sensor, as well as, production of a more robust intrusion detector. The intrusion detector of the present invention is more robust because the amount of an intruder's infrared energy that reaches the pyroelectric elements will be greatly increased compared to typical devices. Typical devices may include lens pigments and secondary filters which reduce the amount of available in-band or select-band infrared energy which is desirable to transmit through the filter. Also, elimination of lens pigmenting and opaquing additives and secondary filters lowers the manufacturing cost of the intrusion device 200.

More specifically, destructive interference according to the illustrative embodiment of the present invention includes applying coating layers 308 to an infrared (IR) transmissive substrate. These coating layers are transmissive of IR, near-IR, and visible light and cause destructive interference of the energy below 5 μm. For example, the coating layers 308 eliminate incident energy between about 0.4 and 5 μm via destructive interference. The coating layers 308 cause destructive interference of the desired specific wavelengths and thereby eliminates heating of the window 204 from absorption. Initially, the coating layers are transmissive of radiation energy 412 in a range of about 0.4 to 25 μm wavelength band, however, within the layers, the differences in the layers indices of refraction combined with specific thicknesses assigned to each layer cause destructive interference 424, as shown in FIG. 5. The destructive interference 424 results from reflection within layers, as shown in FIG. 5, this reflected energy is perfectly out of phase with the incident energy arriving on a given coating layer thereby causing cancellation of the incident energy. A portion of the reflection 416 escapes out the front surface, as shown in FIG. 5. The coating layers 308 are a series of thin layers of materials of alternating high and low indices of refraction. To ensure that heat is not generated by absorbing energy, the coating layers must be transmissive to the wavelengths that are to be blocked (0.4 to 5.0 μm minimum), to the wavelengths that are passed (7.0 to 25 μm), and to the wavelengths between (5.0 to 7.0). For example, possible layer materials that meet the coating layer transmission criteria are:

| Material | Index of Ref | Pass Band (μm)* |
|---|---|---|
| Zinc Selenide (ZnSe) | 2.41 | 0.5 to 20.0 |
| Zinc Sulfide (Cleartran) | 2.20 | 0.36 to 14.0* |
| Silver Bromide (AgBr) | 2.17 | 0.45 to 35.0 |
| Silver Chloride (AgCl) | 1.98 | 0.4 to 25.0 |
| Thallium Chloride (TlCl) | 2.19 | 0.5 to 30.0 |
| Thallium Bromo-Iodide (KRS-5) | 2.37 | 0.58 to 50.0 |
| Thallium Bromide (KRS-6) | 2.18 | 0.4 to 32.0 |
| Cadmium Sulfide (CdS) | 2.2 | .53 to 16.0* |
| Strontium Fluoride | 1.38 | 0.15 to 13.0* |

*in thin layers the pass band may increase significantly
Other materials exist that sufficiently transmit through thin layers in the desired wavelengths.

In another embodiment of the present invention, to implement reflection, a coating 308 (shown in FIGS. 4) reflects wavelengths below about 5.0 μm and passes wavelengths above 7.0 μm. The reflective coating is applied to the substrates and may be a series of thin layers of different materials of alternating high and low indices of refraction to cause reflection or it may be a single coating layer that causes reflection, or it may be multiple coating layers that in combination cause reflection. The radiation energy of wavelengths below about 5.0 μm is reflected, not absorbed. Thereby, the radiation energy does not produce heat from the window 204 absorbing the energy, and avoids the undesirable transmission of the heat to the pyroelectric elements 216 (shown in FIG. 3), and thus substantially eliminates false alarms.

According to the illustrative embodiment of the present invention shown in FIGS. 3 and 4, a combination of reflection and destructive interference includes applying a series of thin layers of different materials of alternating high and low indices of refraction to the substrate to cause destructive interference of some portion of the 0.4 to 5.0 μm wave length band, and single or multiple layers over these layers to cause reflection of the remainder of the 0.4 to 5.0 μm wavelength band. The compilation of all of these layers 308 in combination will prevent heat generation in the window 204. Thus, the pyroelectric sensor device according to the invention effectively shields the sensitive elements in a pyroelectric sensor from the energy associated with automobile head lamps, without further reducing the transmission of the energy emitted by an intruder.

For example, if a reflective layer is applied that reflects wavelengths below 1.0 μm, layers must be applied to achieve destructive interference of the wavelengths in the 1.0 to 5.0 μm band. Therefore, the destructive interference layers will need to be transmissive in the band of 1.0 to 25 μm. If, for example, a reflective layer is applied that reflects wavelengths below 1.8 μm, then layers will be applied to achieve destructive interference of the wavelengths in the 1.8 to 5.0 μm band. Alternatively, if the reflective layers reflect multiple discrete wavelength bands in the band of 0.4 to 5.0 μm, then layers will be applied to cause destructive interference in the bands of wavelengths not reflected in the 0.4 to 5.0 μm band.

While the present invention has been particularly shown and described with respect to preferred embodiments thereof it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. An optical filter device, comprising:
a substrate having a plurality of coating layers on a surface of the substrate, the plurality of coating layers and the substrate being transmissive to a specified wavelength band of radiation; and
the plurality of coating layers on the substrate each having a specified coating thickness, and the plurality of coating layers causing destructive interference of radiation outside the specified wavelength band of radiation while the radiation within the specified wavelength band passes through the substrate and the plurality of coating layers.

2. The device of claim 1, wherein the plurality of coating layers cause destructive interference and reflection of the radiation outside the specified wavelength band of radiation, and the radiation within the specified wavelength band passes through the substrate and the plurality of coating layers.

3. The device of claim 2, wherein the plurality of coating layers on the substrate cause destructive interference of a first group of wavelength bands of radiation outside the specified wavelength band of radiation, and the plurality of coating layers cause reflection of a second group of wavelength bands of radiation outside the specified wavelength band of radiation, and both the first and second groups of wavelengths are different from one another and outside the specified wavelength band of radiation.

4. The device of claim 1, wherein the substrate is positioned between a receiving element and a source of radiation.

5. The device of claim 4, wherein the receiving element includes a pyroelectric element.

6. The device of claim 1, wherein the substrate is positioned in a housing; and
at least one receiving element is positioned within the housing, the substrate is positioned between the at least one receiving element and the source of radiation, and the radiation within the specified wavelength band passes through the substrate and the plurality of coating layers to the at least one receiving element for initiating an electrical signal.

7. The device of claim 6, further including multiple receiving elements.

8. The device of claim 6, wherein the housing is mounted in a case which further includes an electronic device for receiving an electrical signal generated from the at least one receiving element and initiating an alarm signal when a specified level of radiation within the specified wavelength band reaches the at least one receiving element.

9. An optical filter device, comprising:
a substrate having a plurality of coating layers on a surface of the substrate, the plurality of coating layers and the substrate being transmissive to a specified wavelength band of radiation; and
the plurality of coating layers on the substrate each having a specified coating thickness, and the plurality of coating layers causing reflection of radiation outside the specified wavelength band of radiation while the radiation within the specified wavelength band passes through the substrate and the plurality of coating layers.

10. The device of claim 9, wherein the substrate is positioned between a receiving element and a source of radiation.

11. The device of claim 10, wherein the receiving element includes a pyroelectric element.

12. The device of claim 10, further including multiple receiving elements.

13. The device of claim 9, wherein the substrate is positioned in a housing; and
at least one receiving element is positioned within the housing, the substrate is positioned between the at least one receiving element and a source of radiation, and the radiation within the specified wavelength band passes through the substrate and the plurality of coating layers to the at least one receiving element for initiating an electrical signal.

14. The device of claim 13, wherein the housing is mounted in a case which further includes an electronic device for receiving an electrical signal generated from the at least one receiving element and initiating an alarm signal when a specified level of radiation within the specified wavelength band reaches the at least one receiving element.

15. A pyroelectric sensing device, comprising:
a housing;
a substrate attached to the housing, the substrate having a plurality of coating layers on a surface of the substrate, the plurality of coating layers and the substrate being transmissive to a specified wavelength band of radiation;
the plurality of coating layers on the substrate each having a specified coating thickness, and the plurality of coating layers causing destructive interference of radiation outside the specified wavelength band of radiation;
at least one pyroelectric element positioned within the housing, and the substrate positioned between the at least one pyroelectric element and radiation, and the radiation within the specified wavelength band passes through the substrate and the plurality of coating layers to the at least one pyroelectric element for initiating an electrical signal.

16. The device of claim 15, wherein the specified wavelength band is between about 7 and 25 μm (micrometers).

17. The device of claim 15, wherein the plurality of coating layers cause destructive interference below the wavelength of about 5 μm.

18. The device of claim 15, wherein the plurality of coating layers cause destructive interference between about 0.4 to 5 μm.

19. The device of claim 15, wherein the plurality of coating layers cause destructive interference and reflection of the radiation outside the specified wavelength band of radiation while the radiation within the specified wavelength band passes through the substrate and the plurality of coating layers.

20. The device of claim 15, wherein the plurality of coating layers on the substrate cause destructive interference of a first group of wavelength bands of radiation outside the specified wavelength band of radiation, and the plurality of coating layers on the substrate causes reflection of a second group of wavelength bands of radiation outside the specified wavelength band of radiation, and both the first and second groups of wavelength are different from one another and outside the specified wavelength band of radiation.

21. The device of claim 15, wherein the housing is mounted in a case which further includes an electronic device for receiving the electrical signal generated from the at least one pyroelectric element and initiating an alarm signal when the radiation within the specified wavelength band reaches the at least one pyroelectric element and the electronic device determines when the electrical signal exceeded a threshold value.

22. The device of claim 15, wherein the housing is mounted to a printed circuit board (PCB) in the case and further mounted to the PCB is an amplifier for amplifying the electrical signal, and an alarm relay for relaying the alarm signal from the electronic device to a signaling device.

23. A pyroelectric sensing device, comprising:
a housing;
a substrate attached to the housing, the substrate having a plurality of coating layers on a surface of the substrate, the plurality of coating layers and the substrate being transmissive to a specified wavelength band of radiation;
the plurality of coating layers on the substrate each having a specified coating thickness, and the plurality of coating layers causing reflection of radiation outside the specified wavelength band of radiation;
at least one pyroelectric element positioned within the housing, and the substrate positioned between the at least one pyroelectric element and radiation, and the radiation within the specified wavelength band passes through the substrate and the plurality of coating layers to the at least one pyroelectric element for initiating an electrical signal.

24. The device of claim 23, wherein the specified wavelength band is between about 7 and 25 μm (micrometers).

25. The device of claim 23, wherein the plurality of coating layers cause reflection below the wavelength of about 5 μm.

26. The device of claim 23, wherein the plurality of coating layers cause reflection between about 0.4 to 5 μm.

27. The device of claim 23, wherein the housing is mounted in a case which further includes an electronic device for receiving the electrical signal generated from the at least one pyroelectric element and initiating an alarm signal when the radiation within the specified wavelength band reaches the at least one pyroelectric element and the electronic device determines that the electrical signal exceeded a threshold value.

28. The device of claim 23, wherein the housing is mounted to a printed circuit board (PCB) in the case and further mounted to the PCB is an amplifier for amplifying the electrical signal, and an alarm relay for relaying the alarm signal from the electronic device to a signaling device.

29. A method for detecting intrusion, comprising:
providing an optical filter device being transmissive to a specified wavelength band of radiation;
applying a plurality of coating layers on the substrate each having a specified coating thickness;
passing a specified wavelength band of radiation through the coating layers and the substrate; and
interfering destructively with radiation outside the specified wavelength band of radiation using the plurality of coating layers.

30. The method of claim 29, wherein the plurality of coating layers interfering destructively and reflecting the radiation outside the specified wavelength band of the radiation while passing the radiation within the specified wavelength band through the plurality of coating layers and the substrate.

31. The method of claim 30, further comprising the step of:
reflecting a first group of at least one specified wavelength band of the radiation, and destructively interfering a second group of at least one specified wavelength band of the radiation, and both the first and second groups of specified wavelength bands are different from one another and outside the specified wavelength band.

32. The method of claim 29, farther including positioning the substrate between a receiving element and a source of radiation.

33. The method of claim 29, further including:
positioning at least one pyroelectric element within a housing;
positioning the substrate between the at least one pyroelectric element and radiation; and
initiating an electrical signal by passing energy within the specified wavelength band of radiation through the plurality of coating layers and the substrate to the at least one pyroelectric element,

34. A method for detecting intrusion, comprising:
providing an optical filter device being transmissive to a specified wavelength band of radiation;
applying a plurality of coating layers on the substrate each having a specified coating thickness;
passing a specified wavelength band of radiation through the coating layers and the substrate; and
reflecting radiation outside the specified wavelength band of radiation using the plurality of coating layers.

35. The method of claim 34, further including positioning the substrate between a receiving element and a source of radiation.

36. The method of claim 34, further including:
positioning at least one pyroelectric element within a housing;
positioning the substrate between the at least one pyroelectric element and radiation; and
initiating an electrical signal by passing energy within the specified wavelength band of radiation through the plurality of coating layers and the substrate to the at least one pyroelectric element.
